(19) United States
(12) Patent Application Publication
(10) Pub. No.: US 2002/0084739 A1
(43) Pub. Date: Jul. 4, 2002

(54) Cathode ray tube with a deflection unit having a particular cross-sectional configuration

(76) Inventors: Do-nyun Kim, Kyungki-do (KR); Seong-joo Hwang, Kyungki-do (KR)

Correspondence Address: CHRISTIE, PARKER & HALE, LLP, 350 WEST COLORADO BOULEVARD, SUITE 500, PASADENA, CA, 91105, US

(21) Appl. No.: 09/990,140

(22) Filed: Nov. 20, 2001

Related U.S. Application Data
(63) Continuation of application No. 09/287,688, filed on Apr. 6, 1999.

(30) Foreign Application Priority Data
Oct. 1, 1998 (KR) 98-41357
Oct. 2, 1998 (KR) 98-41618

(51) Int. Cl. H01J 29/70

(52) U.S. Cl. 313/440

(57) ABSTRACT

A cathode ray tube has a deflection unit designed to efficiently reduce the required power consumption. The deflection unit comprises a horizontal deflection coil with a non-circular cross-section, a separator placed outside the horizontal deflection coil, with its inner configuration corresponding to the outer configuration of the horizontal deflection coil, a vertical deflection coil placed outside of the separator with its non-circular cross-section corresponding to the outer surface of the separator, and a ferrite core for closely attaching the vertical deflection coil to the separator, with its inner side formed to be similar to the inner configuration of the vertical deflection coil.

### CROSS-REFERENCE TO RELATED APPLICATION(S)

This application is a continuation of application Ser. No. 09/287,688, filed Apr. 6, 1999, which claims the benefit of Korean Application Ser. Nos. 98-41357, filed on Jan. 10, 1998 and 98-41618, filed on Feb. 10, 1998, the contents of which are incorporated herein by reference.

### FIELD OF THE INVENTION

The present invention relates to a cathode ray tube, and more particularly to a cathode ray tube having a deflection unit capable of efficiently reducing power consumption.

### DESCRIPTION OF THE RELATED ART

In a cathode ray tube, electron beams emitted from an electron gun are deflected in the horizontal and vertical directions and land on phosphors coated on a screen to display images. In particular, the electron beams are deflected by the horizontal and vertical magnetic fields generated by a deflection unit mounted on an outer surface of a funnel in a cathode ray tube.

Such cathode ray tubes are widely used in color television and computer monitors, high definition televisions (HDTVs) and other high-tech devices.

In order for a cathode ray tube to be suitable for applications in HDTVs or various office automation equipments, the deflection frequency should be increased and the depth of the tube should be decreased. In order to decrease the depth of the tube, an increase of the deflection power is necessary so that the cathode ray tube could deflect the electron beams at a wider angle. However, an increase in the deflection frequency and the deflection angle require increased power consumption, causing a problem of magnetic field leakage.

In other words, in order to improve the quality of a cathode ray tube, it is essential to reduce the power consumption of the deflection unit while minimizing the magnetic field leakage.

To this end, it was suggested that diameters of the neck and funnel of a CRT abutting the neck be reduced to promote the efficiency of the deflection. However, reduction in the neck diameter also requires a reduction in the diameter of the electron gun, causing a reduced resolution and unstable electron beams at high frequencies. In particular, the electron beams directed to marginal portions of the screen are likely to collide with inner wall of the funnel on the neck side, resulting in a poor image on the screen.

To address these problems, a cathode ray tube, wherein the cross-section of the funnel, on which a deflection yoke is mounted, changes from circular to noncircular along the tube axis, has recently been suggested. This configuration of funnel prevents electron beams from striking the inner wall of the funnel.

With such a funnel structure, a U.S. Pat. No. 3,731,129 discloses a means for reducing a diagonal misconvergence to accomplish a wide deflection angle without increased power consumption.

However, as long as conventional deflection units with circular cross-sectional configurations are applied to these cathode ray tubes, it is difficult to actually reduce the power consumption of the deflection yoke, since the shapes of the conventional deflection units prevent the deflection units from being close to trajectories of the electron beams, and thus, do not reflect the beams power-efficiently.

### SUMMARY OF THE INVENTION

Accordingly, an embodiment of the present invention aims at providing a cathode ray tube with a deflection unit to effectively reduce the power consumption of the deflection unit.

To accomplish this, an embodiment of the present invention provides a deflection unit comprising a horizontal deflection coil having a non-circular cross-section, a separator placed outside the horizontal deflection coil, with an inner configuration corresponding to an outer configuration of the horizontal deflection coil, a vertical deflection coil placed outside of the separator with a non-circular cross-section corresponding to an outer surface of the separator, and a ferrite core for closely attaching the vertical deflection coil to the separator, with its inner side formed to be similar to the inner configuration of the vertical deflection coil.

### BRIEF DESCRIPTION OF THE DRAWINGS

A more complete appreciation of an embodiment of the present invention will be readily apparent as an embodiment of the present invention becomes better understood by reference to the following detailed description when considered in conjunction with the accompanying drawings, wherein:

FIG. 1 is a schematic view of a cathode ray tube of an embodiment of the present invention along with a schematic view of a deflection unit thereof;

FIG. 2 is a cross-sectional view of the deflection unit of FIG. 1 cut along an A-A line;

FIG. 3 indicates a horizontal length L1 and a vertical length L2 of a vertical deflection coil of the deflection unit of an embodiment of the present invention;

FIG. 4 is a graph showing a ratio of L1/L2 of the vertical deflection coil according to a distance of a coil from a funnel;

FIG. 5 is a schematic view of a separator of the deflection unit of an embodiment of the present invention;

FIG. 6 is a schematic view of a ferrite core of the deflection unit of an embodiment of the present invention;

FIG. 7 is a schematic view of a modified ferrite core of the deflection unit of an embodiment of the present invention;

FIG. 8 is schematic view of another ferrite core of the deflection unit of an embodiment of the present invention;

FIG. 9 is a partial cross-sectional view of the cathode ray tube of FIG. 1 according to an embodiment of the present invention with the deflection unit mounted thereto; and

FIGS. 10 and 11 are schematic views illustrating the ferrite core of an embodiment of the present invention connected to the vertical deflection coil according to an embodiment of the present invention.

### DETAILED DESCRIPTION OF THE PREFERRED EMBODIMENTS

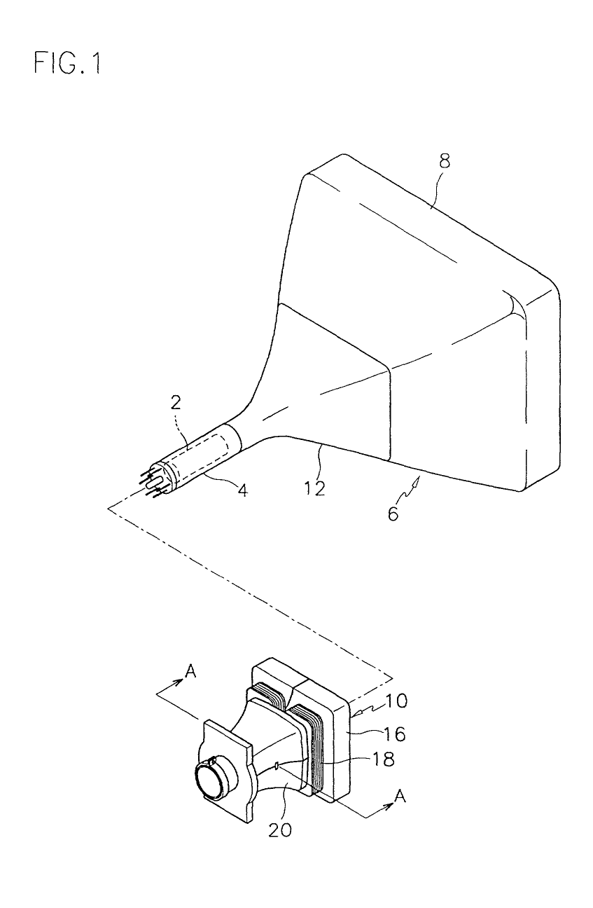

FIG. 1 is a schematic view of a cathode ray tube according to a preferred embodiment of the present invention. The cathode ray tube has a cylindrical neck 4 wherein an electron gun 2 is placed, a funnel portion 6, the neck portion 4, and a panel 8 sealed to the funnel portion 6.

A cone portion is indicated by the reference number 12 in the drawing, on which a deflection unit 10 is to be mounted. The cross-section of the cone portion 12 changes from circular to substantially rectangular as it moves from the neck toward the funnel body.

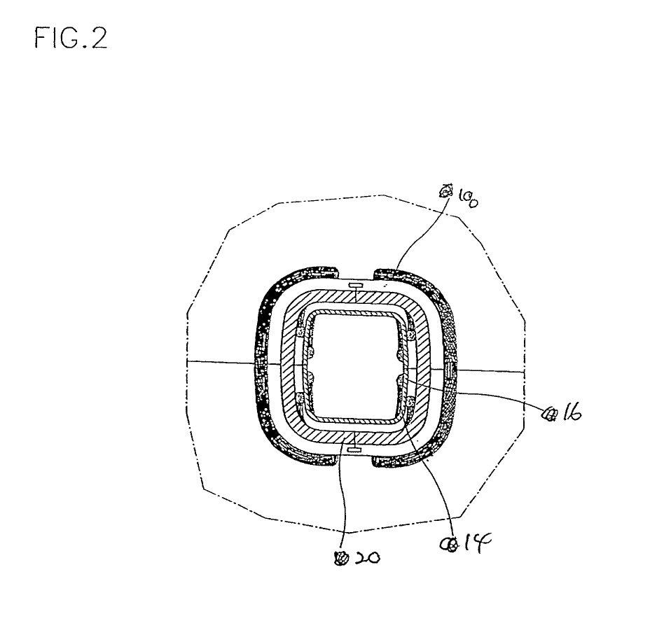

FIGS. 1 and 2 show a deflection unit 10 of an embodiment of the present invention comprising a saddle-like horizontal deflection coil 14 having a noncircular cross-section, a separator 16 placed outside the horizontal deflection coil 14, having its inner configuration corresponding to the outer configuration of the horizontal deflection coil 14, a saddle-like vertical deflection coil 18 placed outside of the separator 16, having non-circular cross-sectional form corresponding to the outer surface of the separator 16 and a ferrite core 20 for closely attaching the vertical deflection coil 18 to the separator 16, having its inner side formed similar to the inner configuration of the vertical deflection coil 18.

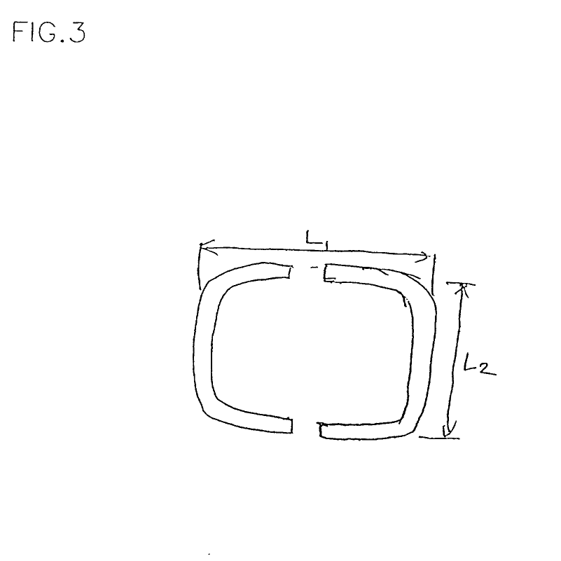

The vertical deflection coil 18 as shown in FIG. 3 has its horizontal length L1 and its vertical length L2 at a ratio of 1.0≦L1/L2≦1.3, at which the power consumption of the deflection is most reduced.

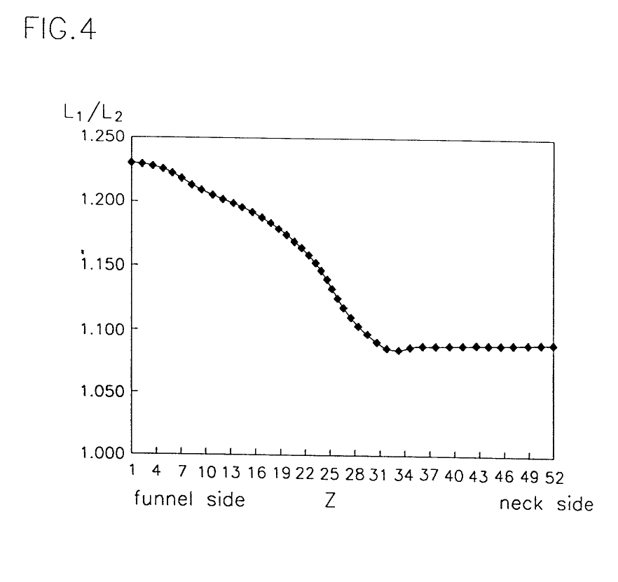

The graph in FIG. 4 shows the ratio of the horizontal length L1 to the vertical length L2 of the vertical deflection coil 18, with Z axis representing the distance from neck seal to the funnel. The deflection unit of an embodiment of the present invention with this ratios consumes 20% less power compared to prior devices.

When the horizontal and vertical deflection coils of the deflection unit each takes substantially rectangular shape, the horizontal and vertical fields generated by the unit also take a form similar to the substantially rectangular panel. This design makes the deflection of electron beams along the diagonals easier than in the conventional devices, and the convergence characteristic is enhanced.

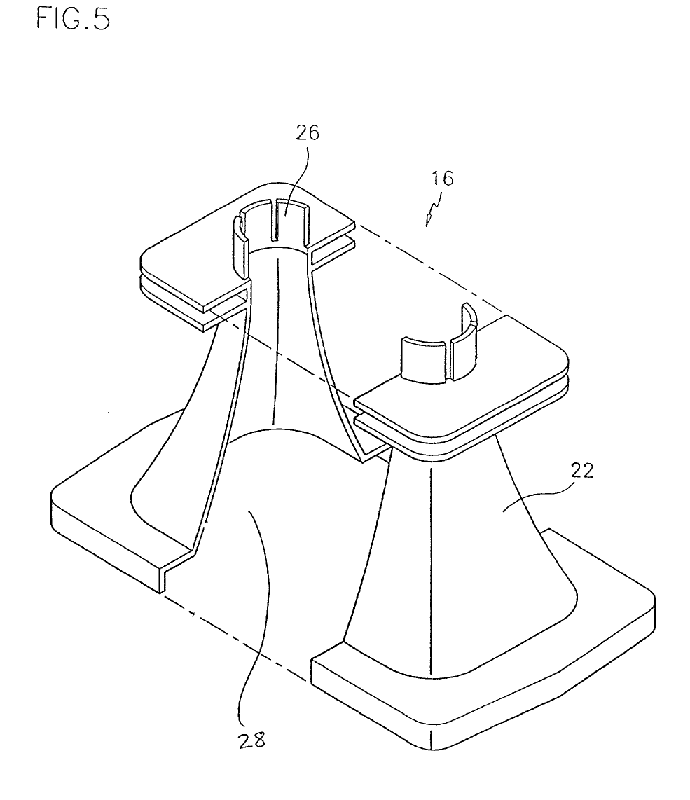

FIG. 5 is a schematic view of a separator in the deflection unit of an embodiment of the present invention. The separator 16 has a body 22 of a substantially rectangular cross-section with an a large opening 28 at one end, through which the funnel 6 of the cathode ray tube will be inserted and a small opening 26 at the other end to be located around the neck of the cathode ray tube. The horizontal deflection coil is positioned on the inner wall of the separator 16 and the vertical deflection coil 18 is positioned outside of the separator 16.

The substantially rectangular cross-sectional body 22 of the separator helps the horizontal and vertical deflection coils 14, 18 to be more closely located to the trajectories of the electron beams, and thus, helps to efficiently carry out the deflection of the electron beams at a wider angle with a result of reduced power consumption.

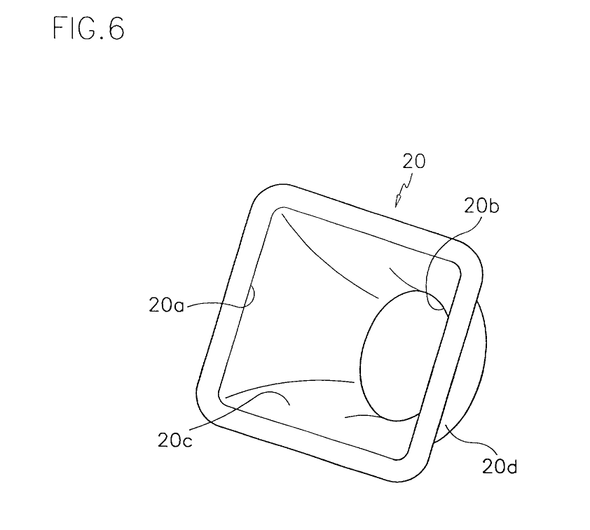

Next, FIG. 6 is a schematic view of a ferrite core 20 according to an embodiment of the present invention. The ferrite core 20 which is mounted on the separator 16 and the vertical deflection coil 18 is shaped similar to the separator 16. The ferrite core 20 has substantially flat inner and outer surfaces 20c and 20d and a large opening 20a at one end and a small opening 20b at the opposite end.

Either the inner surface 20c alone or both of the inner surface 20c and the outer surface 20d have their cross-sectional shapes gradually changing from circular at the small opening 20b to rectangular near the large opening 20a.

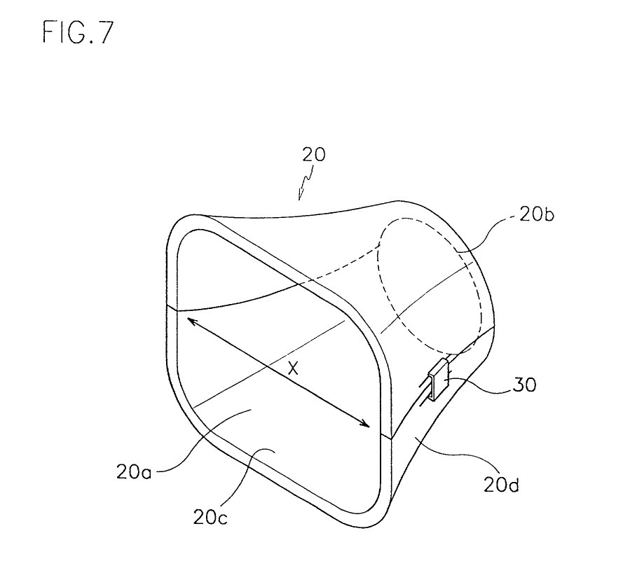

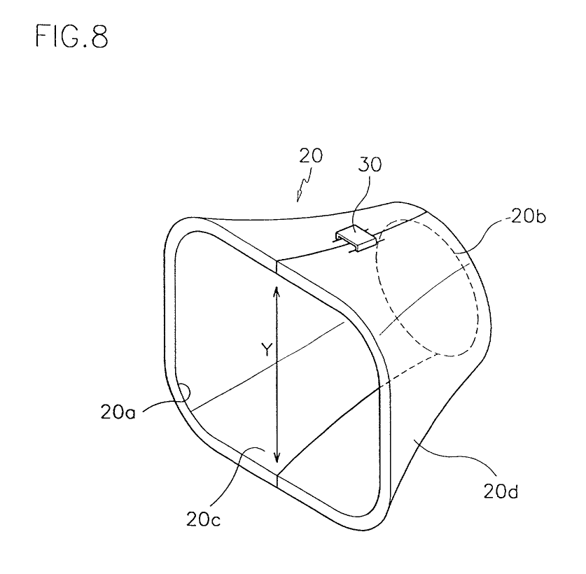

The ferrite core 20 can be made in one piece as in this drawing or can be made with divided portions. The ferrite core 20 in FIG. 7 is formed by combining two sections, upper half and lower half, coupled along the horizontal-axis X as indicated by an arrow. In another embodiment, two halves symmetrical with respect to the vertical axis Y as shown in FIG. 8 can be combined to form the ferrite core.

The two half sections, after being positioned around the separator 16, are joined to each other by using a conventional fixing means such as core clamps 30.

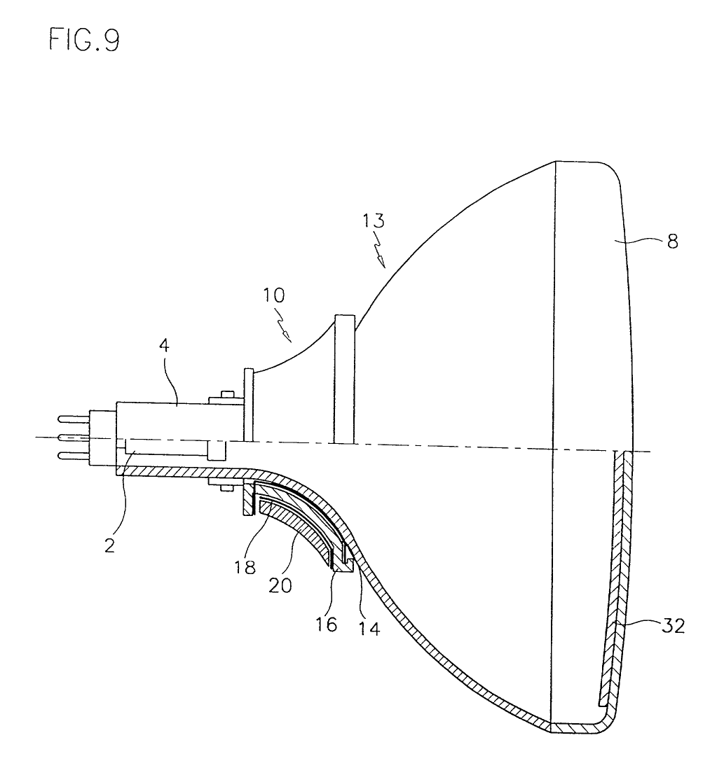

FIG. 9 shows a partial cross-sectional view of the cathode ray tube with respect to the tube axis, having the deflection unit mounted thereto according to an embodiment of the present invention. A phosphor screen 32 is formed inside the panel 8 and the deflection unit 10 is mounted on the cone portion 12. The cross-section of cone portion 12 changes from circular to substantially rectangular shape from the neck to the funnel. In this way, the deflection fields generated by the deflection coils 14 and 18 are formed close to the trajectories of the electron beams, and thereby, deflection of the electron beams by the deflection unit is performed more efficiently than in prior devices.

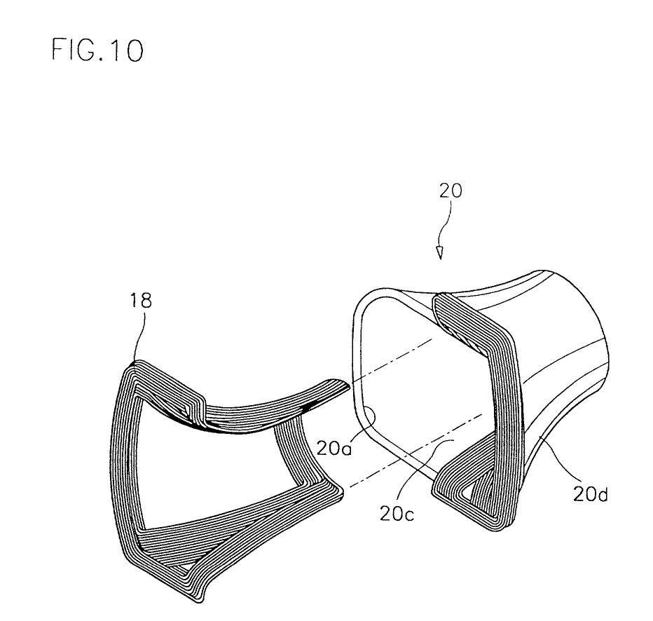

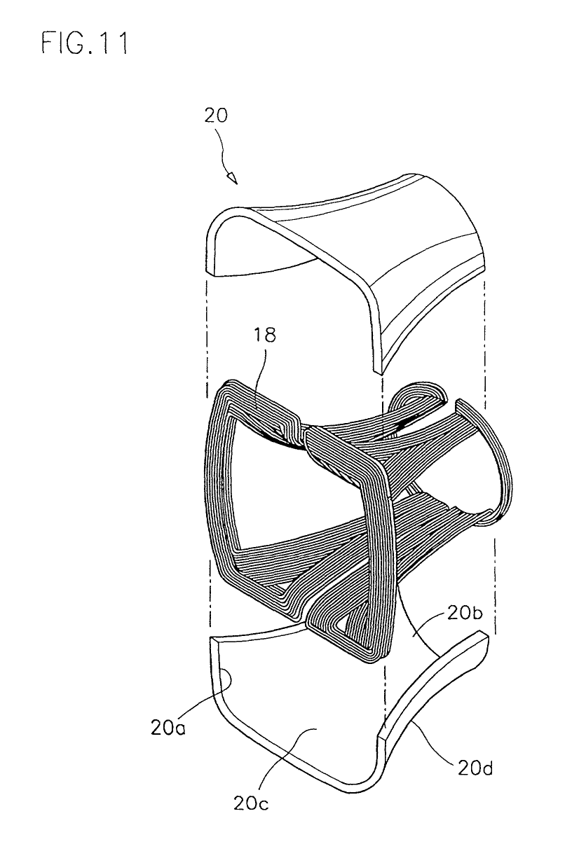

The respective merits between the ferrite core 20 made in one piece and the one made in two separate pieces are described below with reference to FIGS. 10 and 11. In the case of a ferrite core 20 made in one piece as shown in FIG. 10, the vertical deflection coil 18 can be directly and easily inserted and placed into the ferrite core 20.

The vertical deflection coil 18 should be a flangeless type where no flange is formed at the end closer to the neck side of the cathode ray tube. When the deflection coil has a flange at the end near the neck, the ferrite core 20 made in two pieces should be used.

Horizontally or vertically divided ferrite core 20 has following respective merits.

When the ferrite core 20 of FIG. 7 which is horizontally divided along the X-axis is used, the core clamp 30 is attached on the side walls on the outer surface 20d. In this arrangement, one can easily connect the two divided sections of the ferrite core and check the connection status.

A ferrite core 20 of FIG. 8 which is vertically divided along the Y-axis, on the other hand, helps to reduce the magnetic field leakage which might be leaked through small cracks in the connecting portion of the ferrite core 20. Since the cracks in the connecting portion of the ferrite core 20 will not be in the way of the horizontal magnetic field produced by the horizontal deflection coil 14 on which a high frequency is applied, there is less possibility of the magnetic field leakage than when a horizontally divided ferrite core is used.

What is claimed is:

1. A cathode ray tube comprising:
a neck having an electron gun disposed therein;
a funnel contiguous to the neck, said funnel having a cross-section that changes from circular at one end near the neck to substantially rectangular at an opposite end; and
a deflection unit mounted on the funnel, said deflection unit comprising:
a horizontal deflection coil having a non-circular cross-sectional configuration,
a separator placed outside the horizontal deflection coil, said separator having an inner configuration similar to an outer configuration of the horizontal deflection coil,
a vertical deflection coil placed outside the separator, said vertical deflection coil having a non-circular cross-sectional configuration similar to an outer surface of the separator, wherein a ratio of a horizontal length L1 to a vertical length L2 of the vertical deflection coil is 1.0 L1/L2 1.3, and
a ferrite core attaching the vertical deflection coil to the separator, said ferrite core having an inner surface similar to an inner configuration of the vertical deflection coil.

2. A cathode ray tube according to claim 1, wherein the ferrite core of the deflection unit is comprised of at least two separate portions.

3. A cathode ray tube according to claim 2, wherein the two separate portions are symmetrical with respect to the horizontal-axis thereof.

5. A cathode ray tube according to claim 2, wherein the two separate portions are symmetrical with respect to the vertical-axis thereof.
